(19) United States
(12) Patent Application Publication
(10) Pub. No.: US 2005/0144243 A1
(43) Pub. Date: Jun. 30, 2005

(54) Multi-language wireless email transmission method for mobile communication

(75) Inventor: Sze Kuen Cheng, Hung Hom (HK)

Correspondence Address: LEYDIG VOIT & MAYER, LTD, 700 THIRTEENTH ST. NW, SUITE 300, WASHINGTON, DC, 20005-3960, US

(73) Assignee: Hutchison Whampoa Enterprises Limited, Road Town (VG)

(21) Appl. No.: 10/991,486

(22) Filed: Nov. 19, 2004

(30) Foreign Application Priority Data
Dec. 29, 2003 (GB) 0330081.1

(51) Int. Cl. G06F 15/16

(52) U.S. Cl. 709/206

(57) ABSTRACT

A method of wireless transmission of an email having a content in a language unsupported in a mobile communication system by Multimedia Messaging Service (MMS) to a recipient using a mobile phone. An email server receives the email and extracts from the email text information indicative of the recipient and relating to content. A conversion server, connected to the email server, converts the content information from text into an image and composes a MMS message including the image. A MMS message transmitter, connected to the conversion server, transmits the MMS message to the mobile phone. Multi-language (supported and unsupported languages) wireless email transmission is thus made possible.

The present invention relates to a multi-language wireless email transmission method for mobile communication using Multimedia Messaging Service (MMS) for mobile phones including 2.5 G and 3 G phones.

### BACKGROUND OF THE INVENTION

Increasingly mobile phones are data capable and services are gaining popularity for both consumer and corporate markets for wireless access to personal and corporate emails.

Mobile phones are market specific in terms of language support. The lowest common denominator is English, for example mobile handsets sold in Hong Kong and China all support English and all variances of Chinese characters (both simplified Chinese character set and traditional Chinese character set), whereby email access is made possible for these supported languages.

There are however exceptions, for example (a) Japanese and Korean languages are not supported by the GSM (Global System for Mobile Communications) handsets, and (b) the CDMA (Code Division Multiple Access) system only supports English and Chinese (and Japanese and Korean) and is not implemented in many countries. In general, mobile handsets sold in one geographical market often do not support minority languages e.g. handsets sold in Hong Kong do not support Hebrew (Israel).

The invention seeks to mitigate or at least alleviate such a problem by providing a multi-language wireless email transmission method to enhance mobile handset based wireless email services by supporting an otherwise unsupported language.

### SUMMARY OF THE INVENTION

According to the invention, there is provided a method of wireless transmission of an email having a content in a language unsupported in a mobile communication system by Multimedia Messaging Service (MMS) to a recipient using a mobile phone operating in said system, the method comprising the following steps:

(a) providing an email server for receiving the email and extracting from that email text information indicative of the recipient and relating to the content;

(b) providing a conversion server connected to the email server for converting the content information from text into an image and composing a MMS message including the image; and

(c) providing a MMS message transmitter connected to the conversion server for transmitting the MMS message to the mobile phone.

Preferably, step (a) includes creating a text file for storing the content information for subsequent retrieval by the conversion server.

More preferably, step (a) further includes providing first means for regularly checking the text file for the content information and, upon detection of the content information, retrieving the content information and composing an extensible Markup Language (XML) file including the content information for subsequently sending the XML file to the conversion server in hyper text transfer protocol.

It is preferred that step (b) includes programming the conversion server using ASP.NET for said operation.

In a preferred embodiment, step (b) includes creating an image file for storing the image for subsequent composing into the MMS message.

More preferably, step (b) further includes providing second means for regularly checking the image file for the image and, upon detection of the image, retrieving the image for composing the MMS message for subsequently sending the MMS message to the MMS message transmitter in Transmission Control Protocol.

It is preferred that the wireless email transmission method includes the step of providing a subscription database connected to the email server for storing data relating to recipients who subscribe to using the method, the data including device type data relating to mobile phones used by individual recipients.

It is further preferred that step (a) includes retrieving the device type data associated with the recipient from the database for use in step (b) for converting the content information into an image for optimum display on a screen of the mobile phone.

Preferably, the device type data indicates the models of said mobile phones.

### BRIEF DESCRIPTION OF DRAWINGS

The invention will now be more particularly described, by way of example only, with reference to the accompanying drawings, in which:

FIG. 1 is a schematic flowchart illustrating the operation of an embodiment of a multi-language wireless email transmission method for mobile communication in accordance with the invention;

FIG. 2 is a printout of a sample email from a sender for transmission using the method of FIG. 1;

FIG. 3 shows the email of FIG. 2 as initially captured by the method of FIG. 1;

FIG. 4 shows the email of FIG. 3, which has subsequently been composed in an XML (extensible Markup Language) format by the method of FIG. 1, being displayed in a hexadecimal editor in both decimal and hexadecimal for clarity; and

FIG. 5 is a screen display of the email of FIG. 2 as finally received by a mobile phone.

### DETAILED DESCRIPTION OF PREFERRED EMBODIMENT

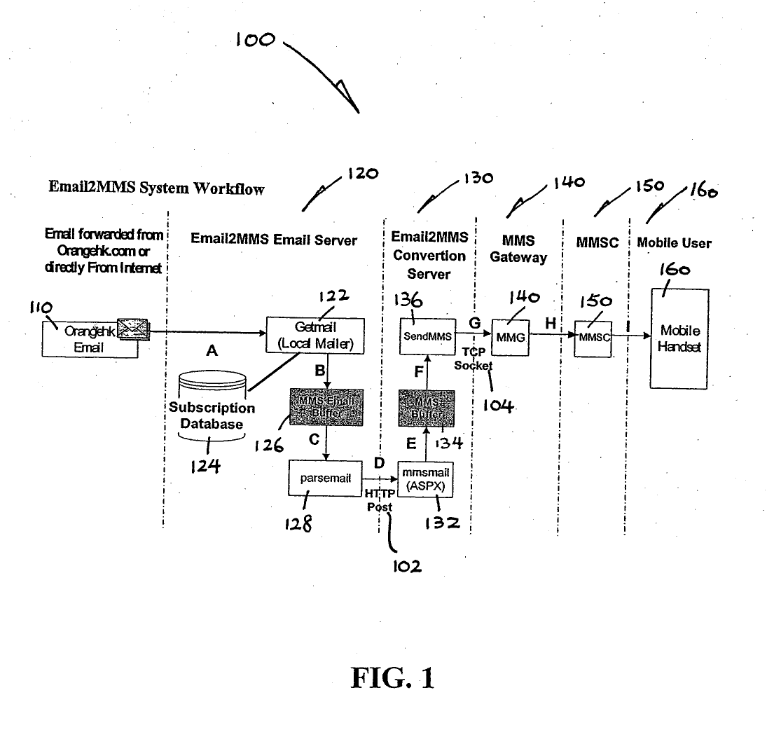

Reference is initially made to FIG. 1 of the drawings, which shows an email transmission system 100 adopting a method embodying the invention for transmitting an email having a content in a language unsupported in a mobile communication system by Multimedia Messaging Service (MMS), thereby providing multi-language wireless email services. The system 100 comprises an email station 110, an email server 120, an email-to-MMS conversion server 130, a MMS gateway (MMG) 140, a MMS centre (MMSC) 150 and a mobile phone 160 of a recipient using the email service. All of these major components are generally known and therefore their construction and operation will not be fully described for clarity, except in specific details as hereinafter described.

The email station 110 symbolizes a source of emails issued by or transmitted from various senders, which may take the form of a website named “Orangehk.com” as provided by the Internet Service Provider in the case of the described embodiment. Alternatively or in addition, the station 110 may represent corporate participants utilising the subject email service, who are identified by reference to a specific gateway IP (Internet Protocol) address for verification.

The email server 120 comprises a local mailer 122 running a Getmail program, a subscription database 124 connected thereto for storing subscription data of all users, a MMS email buffer 126 connected to the local mailer 122, and a parsemail program module 128 connected to the MMS email buffer 126.

The conversion server 130 comprises a mmsmail program module 132 connected to the parsemail module 128 by a HTTP (Hyper Text Transfer Protocol) post, a MMS buffer 134 connected to the mmsmail module 132, and a SendMMS program module 136. The MMS gateway 140 is connected to the SendMMS module 136 via a TCP (Transmission Control Protocol) socket 104, whereas the MMS centre 150 connects the MMS gateway 140 to the mobile phone 160. The mobile phone 160 is designed to operate in the local mobile communication system, such as the GSM (Global System for Mobile Communications) system or CDMA (Code Division Multiple Access) system as implemented in the market concerned.

The content embedded in the email for transmission may be in a supported language (e.g. English) in which case the message will be processed in the conventional manner, or in an unsupported language (e.g. Japanese, Korean or Hebrew) in which case the subject method will be invoked. A language is unsupported in the sense that it is not supported by the local mobile communication network i.e. GSM in the present case, the local market i.e. a minority language not catered for in mobile communication, and/or the recipient device i.e. the mobile phone 160.

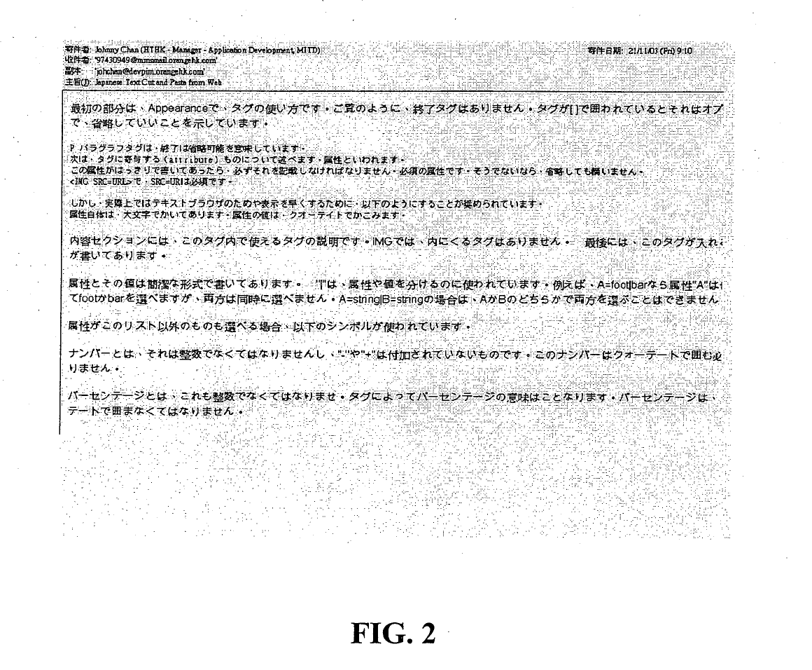

The subject email transmission method is now described by reference also to FIGS. 2 to 5. Initially, all users wishing to use the subject service for receiving emails are required to register/subscribe at “Orangehk.com” 110 by, inter alia, opening an email account and entering all relevant data which is then stored in the subscription database 124. The subscription data includes the users' mobile phone numbers and device type data as designated by the model numbers of their phones specified for use, which are needed to ascertain the display type and resolution of the handset screens and in turn determine how received messages are to be displayed.

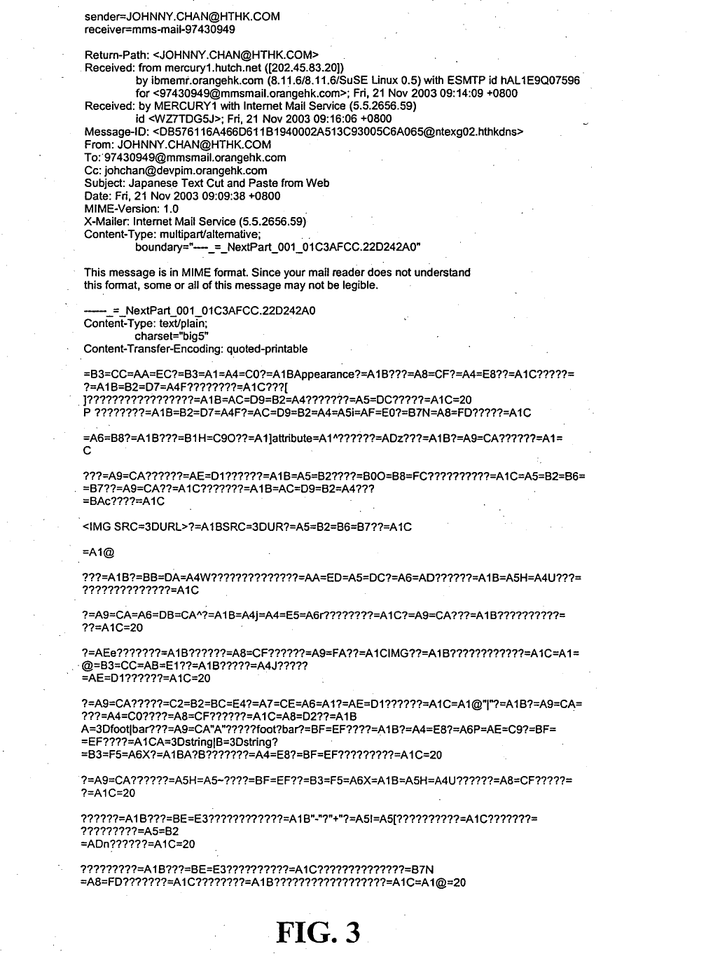

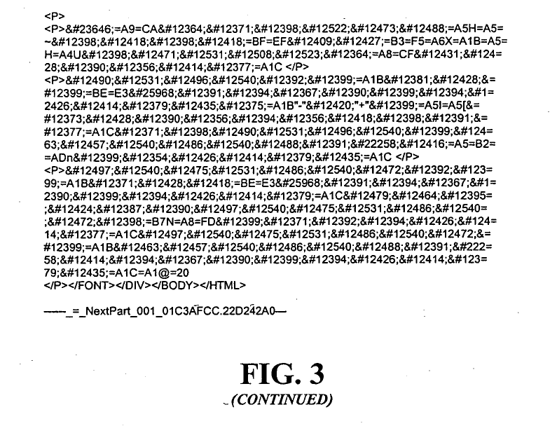

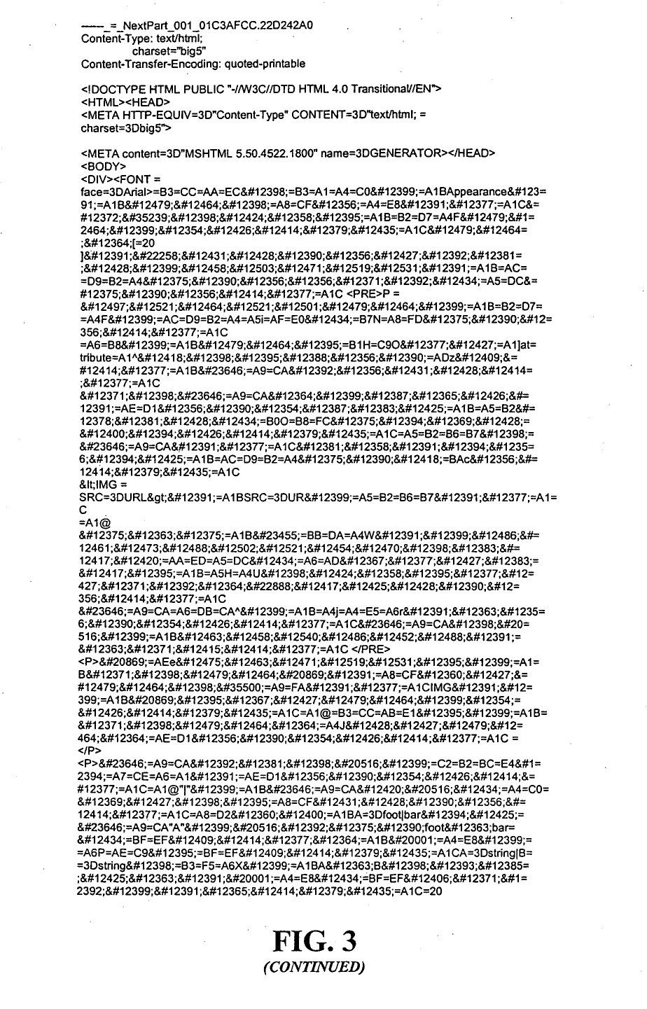

Each subscribed recipient will be assigned with two email addresses. For example, if the recipient is “Joh Chan” using a mobile phone number “97430949”, he will be given a normal email address “johchan@orangehk.com” (instead of “johchan@devpim.orangehk.com” as shown in FIGS. 2 and 3 that is only used during development and testing) that he chooses for himself during subscription and an auxiliary email address “97430949@mmsmail.orangehk.com” generated for receiving emails by his mobile phone. In use, the recipient will probably forward all his emails to one of these two addresses (perhaps selectively through definition of auto-forward rules), and senders (companies or friends) can still send emails to him at his normal address through the Internet (either wireless or not) and a copy of which will automatically be sent to the auxiliary address at the same time.

Upon the receiving an email having a content in an unsupported language e.g. Japanese (FIG. 2) from “Orangehk.com” 110, the local mailer 122 will first verify with the subscription database 124 that the message is intended for a subscribed recipient (Step A). If this is not the case, the email will be dropped by the Getmail program 122. In this regard, whether or not the email sender is a subscribed user is irrelevant. The received message is captured at the local mailer 122 in a MIME (Multipurpose Internet Mail Extensions) format (FIG. 3), which includes a font file of character codes representing the characters (and/or letters) that constitute the email content.

If the intended recipient is a subscribed user, the Getmail program 122 will extract information from the captured email, including the handset display type and resolution data associated with that particular user retrieved from the database 124, and write them to an individual plain text buffer file at a specific directory in the MMS Email Buffer 126 (Step B). Such email information comprises the following separate items:

(a) Sender—Email sender

(b) Recipient—Email recipient

(c) MMS Type—MMS resolution type for the recipient's handset screen as specified during subscription

(d) Content—Email content

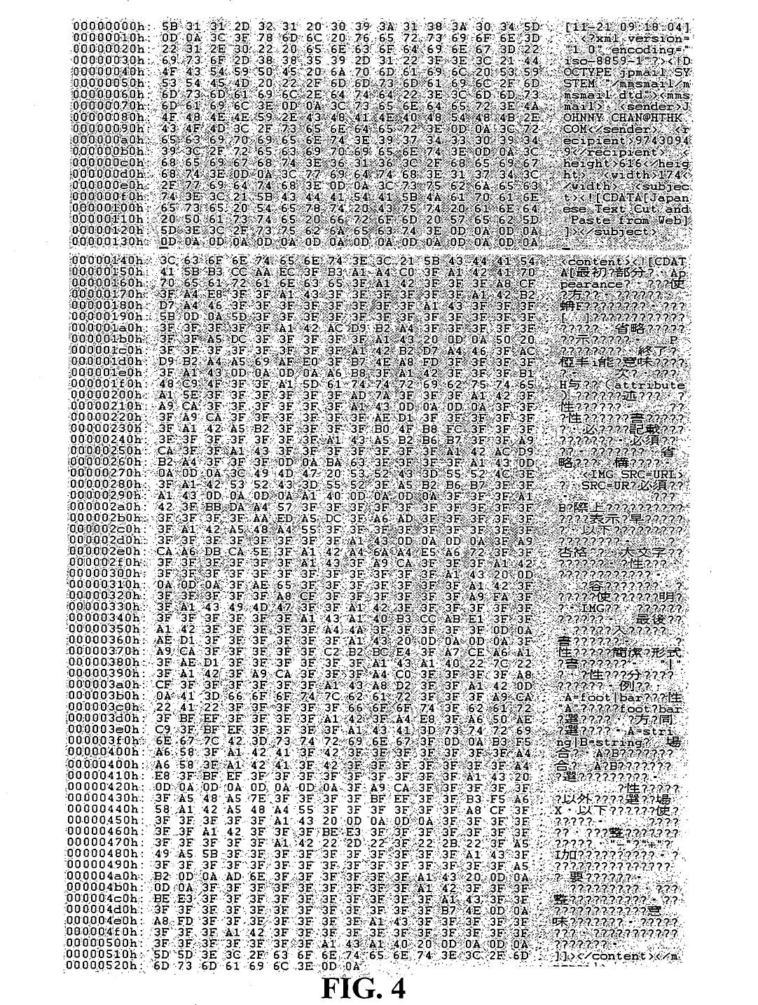

The parsemail program 128 regularly checks the specific directory of the MMS Email Buffer 24 to look for new messages and will, upon detecting a new message, open the relevant buffer file and retrieve the aforesaid email information (Step C). The parsemail program 128 will subsequently compose an XML (eXtensible Markup Language) formatted file incorporating such email information (FIG. 4) and submit the XML file to the mmsmail module 132 via the HTTP post 102 (Step D). In the XML file, all the four items of the email information remain separate. Upon successful sending of the XML file, the parsemail program 128 will delete the corresponding email buffer file and then proceed to examine other buffer files, otherwise the buffer file concerned will be kept for processing in the next round.

The mmsmail program 132 is an ASP (Active Server Page) program written using the ASP.NET server as provided by Microsoft® to perform the following tasks. The program 132 serves to receive and decode the XML file incoming via the HTTP post 102, and then parse the XML file to retrieve therefrom the email information, i.e. the sender, recipient, MMS type and content. Subsequently, the program 132 will convert the content from the original text format to an image format, such as “.gif” (Graphic Interchange Format) format, based on the MMS type information, and then write the relevant “.gif” file to a specific folder in the MMS Buffer 134. In addition, the sender and recipient information together with certain other information relating to the “.gif” file for later MMS encoding will be written to an “.info” file in the same the MMS Buffer folder (Step E).

The SendMMS program 136 regularly checks the specific folder of the MMS Buffer 134 (Step F) to look for the “.gif” and “.info” files and will, upon detection of both files, retrieve them and compose them into an MMS message file in MIME format and then submit the MMS file to the MMS Gateway 140 via the TCP socket 104 (Step G). After the MMS message has been sent successfully, the program 136 will delete the corresponding “.gif” and “.info” files and then continue with other buffer files, otherwise the files concerned will be kept for processing in the next round.

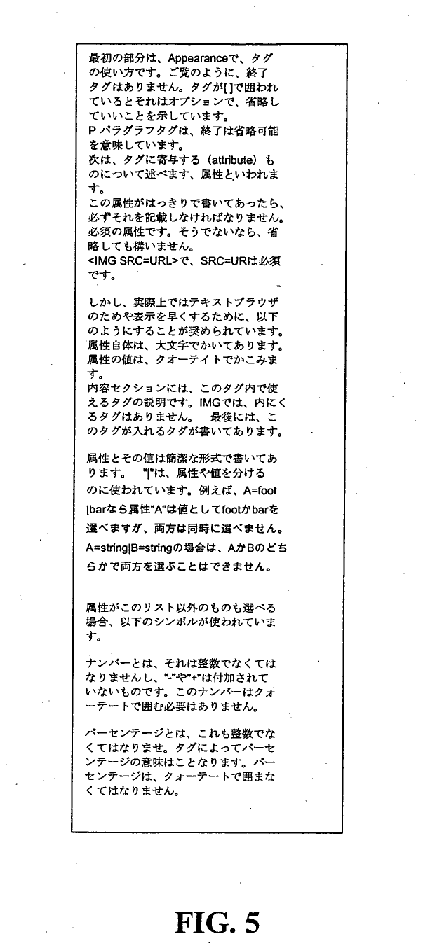

Upon receiving the MMS message, the MMS Gateway 140 will forward it to the MMS centre 150 (Step H) for subsequent transmission and pushing to the recipient's mobile phone 160 (Step I) for display on its screen (FIG. 5). The recipient information is included in the MMS message for transmission, and the sender information will be shown in the subject line on the handset screen and the email content displayed as an image.

Referring back to the conversion of the text content of the email into an image, the associated MMS type information includes the resolution (or size) of the screen of the mobile phone specified by the recipient e.g. 616 dots [h]×174 dots [w], and the screen/display type e.g. zoom capable or not. A specific MMS type is predetermined for the screen of every suitable mobile phone model available on the market. The conversion is to be performed on a character by character basis using the character codes included in the captured email message (FIG. 3) in conjunction with the relevant True Type Font. The image is to be constructed from the top line downwards as will be appearing on the handset screen.

For zoom capable handset screens, the MMS type is predetermined such that the image will be constructed with a relatively large font size for optimum clarity and easy reading. For those handset screens that do not have a zoom function, the MMS type is chosen for image construction using a smaller font size to allow as many characters as possible to be displayed on the screen, with the rest (bottom) of the message being truncated for optimum viewing.

Further development of the subject invention will allow future enhancement to usability, for example the MMS imaging technique could be expanded to allow view of an entire email through multiple MMS image split.

The subject invention is advantageous over other methods, in that (a) as the MMS messages are pushed through to the recipients' handsets, there is no need for the users to access to their Inbox frequently to check for new messages, and (b) the MMS images (email contents) are stored in the handsets and are readily available for reading at any time, even in areas with no mobile phone coverage. Other advantages include adaptability to more capable mobile phones, such as new models with larger screens, more memory and more advanced MMS image zoom functionality, and expansion to cover other unsupported languages suitable for implementation on demand in the target market.

It is emphasized that the subject wireless email transmission method does not involve the sender at all or is sender independent, in that only the recipient has to configure himself during subscription before using the service and no action by or notification to the or any sender will be required. As such, the sender is not aware of anything and may simply send an email to the recipient in the normal way.

By supporting an otherwise unsupported language in email transmission as well as at least one supported language of course, the subject method enables multi-language email transmission. The subject invention is intended for mobile communication and, as such, it is specific to all types of WAN (Wide Area Network) networks for mobile devices whilst it is not applicable to wireless LAN (Local Area Network) or fixed line or broadband email transmission.

The invention has been given by way of example only, and various other modifications of and/or alterations to the described embodiment may be made by persons skilled in the art without departing from the scope of the invention as specified in the appended claims.

1. A method of wireless transmission of an email having a content in a language unsupported in a mobile communication system by Multimedia Messaging service (MMS) to a recipient using a mobile phone operating in the mobile communications system, the method comprising:
(a) providing an email server for receiving the email and extracting from the email text recipient information indicative of the recipient and content information relating to the content;
(b) providing a conversion server connected to the email server for converting the content information from text into an image and composing a mms message including the image; and
(c) providing a mms message transmitter connected to the conversion server for transmitting the mms message to the mobile phone:

2. The wireless email transmission method as claimed in claim 1, whereine (a) includes creating a text file for storing the content information for subsequent retrieval by the conversion server.

3. The wireless email transmission method as claimed in claim 2, wherein (a) further includes providing first means for regularly checking the text file for the content information and, upon detection of the content information, retrieving the content information and composing an eXtensible Markup Language (XML) file including the content information for subsequently sending the XML file to the conversion server in hyper text transfer protocol.

4. The wireless email transmission method as claimed in claim 1, wherein (b) includes programming the conversion server using ASP.NET.

5. The wireless email transmission method as claimed in claim 1, wherein (b) includes creating an image file for storing the image for subsequently composing into the MMS message.

6. The wireless email transmission method as claimed in claim 5, wherein (b) further includes providing second means for regularly checking the image file for the image and, upon detection of the image, retrieving the image for composing the MMS message for subsequently sending the MMS message to the MMS message transmitter in Transmission Control Protocol.

7. The wireless email transmission method as claimed in claim 1, including providing a subscription database connected to the email server for storing data relating to recipients who subscribe to using the method, the data including device data relating to mobile phones used by individual recipients.

8. The wireless email transmission method as claimed in claim 7, wherein (a) includes retrieving the device data associated with the recipient from the database for use in converting the content information into an image for display on a screen of the mobile phone.

9. The wireless email transmission method as claimed in claim 7, wherein the device data indicates models of the mobile phones.

10. A method of wireless transmission of an email having a content in a language unsupported in a mobile communication system by Multimedia Messaging Service (MMS) to a recipient using a mobile phone operating in the mobile communications system, the method comprising:
(a) receiving the email and extracting from the email text recipient information indicative of the recipient and content information relating to the content;
(b) converting the content information from text into an image and composing a MMS message including the image; and
(c) transmitting the MMS message to the mobile phone.

11. The wireless email transmission method as claimed in claim 10, including creating a text file for storing the content information for subsequent retrieval.

12. The wireless email transmission method as claimed in claim 11, including regularly checking the text file for the content information and, upon detection of the content information, retrieving the content information and composing an eXtensible Markup Language (XML) file including the content information for subsequently sending the XML file in hyper text transfer protocol.

13. The wireless email transmission method as claimed in claim 10, including creating an image file for storing the image for subsequently composing the MMS message.

14. The wireless email transmission method as claimed in claim 13, including regularly checking the image file for the image and, upon detection of the image, retrieving the image for composing the MMS message for subsequently sending the MMS message in Transmission Control Protocol.

15. The wireless email transmission method as claimed in claim 10, including storing in a database data relating to recipients who subscribe to the method, the data including device data relating to mobile phones used by individual recipients.

16. The wireless email transmission method as claimed in claim 15, including retrieving the device data associated with the recipient from the database for converting the content information into an image for display on a screen of the mobile phone.

17. The wireless email transmission method as claimed in claim 15, wherein the device data indicates the models of the mobile phones.
